(19) United States
(12) Patent Application Publication
(10) Pub. No.: US 2018/0224350 A1
(43) Pub. Date: Aug. 9, 2018

(54) Method and Apparatus to Infer Structural Response from User-Device Measurements

(71) Applicant: Southern Methodist University, Dallas, TX (US)

(72) Inventors: Brett Story, Rockwall, TX (US); Dinesh Rajan, Dallas, TX (US); Joseph Camp, Dallas, TX (US); Matthew Napier-Jameson, Dallas, TX (US)

(21) Appl. No.: 15/800,990

(22) Filed: Nov. 1, 2017

Related U.S. Application Data
(60) Provisional application No. 62/415,654, filed on Nov. 1, 2016.

(51) Int. Cl. G01M 5/00

(52) U.S. Cl. CPC G01M 5/005; H04M 1/0202; G01M 5/0066; G01M 5/0008

(57) ABSTRACT

The present invention includes a method for detecting impairments of a structure in the absence of permanent sensor systems comprising: obtaining time-varying sensor data on a user device; filtering the time-varying sensor data obtained by the user device to determine a vibration response from structural infrastructure; and estimating structural responses of the structure by comparing at least one of: dynamic (short-term) sensor data to an analytical model of the structure; or dynamic sensor data from different user devices at different points in time (long-term), to determine if there has been any significant change in the structure with time.

### CROSS-REFERENCE TO RELATED APPLICATIONS

This application is a non-provisional patent application of and claims priority to U.S. provisional patent application Ser. No. 62/415,654 filed on Nov. 1, 2016 and entitled “Method and Apparatus to Infer Structural Response from User-Device Measurements”, the contents of which are hereby incorporated by reference in their entirety.

### STATEMENT OF FEDERALLY FUNDED RESEARCH

None.

### TECHNICAL FIELD OF THE INVENTION

The present invention relates in general to the field of the study of structural systems, and more particularly, to a method using user-device measurements to infer structural responses of infrastructure.

### BACKGROUND OF THE INVENTION

Without limiting the scope of the invention, its background is described in connection with assessing dynamic behavior of structural systems.

Acceleration data is one ubiquitous method of assessing dynamic behavior of structural systems (Farrar et al. 2001, Brownjohn 2007, Antunes et al. 2014). Dynamic characteristics such as natural frequency and acceleration magnitudes are readily estimated through implementation of piezoelectric, MEMS or other acceleration devices (Antunes et al. 2014, Ha et al. 2013, Park et al. 2005). Widespread implementation has been hindered by: instrumentation cost, installation and maintenance logistics, and data processing issues. The proposed method circumvents many of these issues by leveraging data from smartphones carried by those utilizing structural systems (e.g. bridges, walkways). Cell phones have been used to collect data from structures before (Feng et al. 2015, Ozer et al. 2015). Feng et al. confirms that the micro-electro-mechanical (MEMS) accelerometers found in smart phones record acceleration data comparable to a research grade piezoelectric accelerometer. Ozer et al. 2015 focuses on the data acquisition and storage of crowd sourced data; the engineering quantities of interest in this study were limited to natural frequencies.

### SUMMARY OF THE INVENTION

In contrast to prior methods, the present invention method uses community-driven data to obtain data from infrastructure to provide direct feedback on the health of the structure in a field setting in real-time or nearly real-time. Thus, in one embodiment the present invention includes a method for detecting impairments of a structure in the absence of permanent sensor systems comprising: obtaining time-varying sensor data on a user device; filtering the time-varying sensor data obtained by the user device to determine a vibration response from structural infrastructure; and estimating structural responses of the structure by comparing the dynamic (short-term) sensor data to an analytical model of the structure; also comparing the dynamic sensor data from different user devices at different points in time (long-term) to determine if there has been any significant change with time. In one aspect, the time-varying sensor information on the smartphone is selected from 3D accelerometer, gyroscope and GPS information. In another aspect, the time-varying sensor information is obtained without user-specific identification. In another aspect, the time-varying sensor information is uploaded to a server and stored for subsequent analysis. In another aspect, the time-varying sensor data is filtered to remove frequencies of vehicle used to collect data. In another aspect, to distinguish vibration response of supporting structural infrastructure is selected from frequencies and/or acceleration time histories. In another aspect, the finding of significant changes triggers additional action to closely inspect the structure for potential impairments. In another aspect, the user device comprises an application that requires user opt-in to gather the time-varying sensor data. In another aspect, the method further comprises the converting of the time-varying sensor data directly into at least one of: displacements, strains, or stresses to determine the response of the structure and characterize the fatigue environment. In another aspect, the method further comprises calculating a structural behavior profile from analytical models for a typical structure and comparing the structural behavior profile to the time-varying sensor data obtained from the user devices to the calculated structural behavior profile. In another aspect, the steps of obtaining time-varying sensor data; filtering the time-varying sensor data; and estimating structural responses is conducted via a code segment in non-transitory memory.

In another embodiment, the present invention also includes a method for detecting impairments of a structure in the absence of permanent sensor systems comprising: obtaining time-varying sensor data on a smartphone with an application that requires user opt-in to gather the time-varying sensor data; filtering the time-varying sensor data obtained by the smartphone to distinguish vibration response of the structure that includes at least one of: 3D accelerometer, gyroscope and GPS information; and estimating structural responses of the structure to an analytical model and an existing data set for the same structure from the time-varying sensor data obtained from different smartphones to determine if there has been any significant change in the structure with time. In one aspect, the time-varying sensor information is obtained without user-specific identification. In another aspect, the time-varying sensor information is uploaded to a server and stored for subsequent analysis. In another aspect, the time-varying sensor data is filtered by vehicle frequencies. In another aspect, to distinguish vibration response of supporting structural infrastructure is selected from frequencies and/or acceleration time histories. In another aspect, the finding of significant changes triggers additional action to closely inspect the structure for potential impairments. In another aspect, the smartphone comprises an application that requires user opt-in to gather the time-varying sensor data. In another aspect, the method further comprises the step of converting the time-varying sensor data directly into at least one of: displacements, strains, or stresses to determine the response of the structure and characterize the fatigue environment. In another aspect, the method further comprises the step of calculating a structural behavior profile from analytical models for a typical structure and comparing the structural behavior profile to the time-varying sensor data obtained from the smartphone to the calculated structural behavior profile.

Yet another embodiment of the present invention includes a non-transitory computer readable medium for detecting impairments of a structure in the absence of permanent sensor systems via crowdsourcing, comprising instructions stored thereon, that when executed by a computer having a communications interface, one or more databases and one or more processors communicably coupled to the interface and one or more databases, perform the steps comprising: obtaining time-varying sensor data on a user device; filtering the time-varying sensor data obtained by the user device to distinguish vibration response of the structure that includes at least one of: 3D accelerometer, gyroscope and GPS information; and estimating structural responses of the structure to an analytical model and an existing data set for the same structure from the time-varying sensor data obtained from different user devices to determine if there has been any significant change in the structure with time; and at least one of storing or displaying the results obtained thereby.

Yet another embodiment of the present invention includes a computerized method for detecting impairments of a structure in the absence of permanent sensor systems via crowdsourcing, comprising: obtaining time-varying sensor data on a user device; filtering the time-varying sensor data obtained by the user device to distinguish vibration response of the structure that includes at least one of: 3D accelerometer, gyroscope and GPS information; estimating structural responses of the structure to an analytical model and an existing data set for the same structure from the time-varying sensor data obtained from different user devices to determine if there has been any significant change in the structure with time; and at least one of storing or displaying the results obtained thereby.

### BRIEF DESCRIPTION OF THE DRAWINGS

For a more complete understanding of the features and advantages of the present invention, reference is now made to the detailed description of the invention along with the accompanying figures and in which:

FIG. 1 is a flow diagram for separating user device and infrastructure responses.

FIG. 2 includes three graphs that provide the frame SRE Lab Summary.

FIG. 3 shows the SRE frequency estimation for the stationary test.

FIG. 4 shows the unfiltered frequency response of the walking test (Bike Walk Test: Bridge vs. Cell Phone response (after SRE)).

### DETAILED DESCRIPTION OF THE INVENTION

While the making and using of various embodiments of the present invention are discussed in detail below, it should be appreciated that the present invention provides many applicable inventive concepts that can be embodied in a wide variety of specific contexts. The specific embodiments discussed herein are merely illustrative of specific ways to make and use the invention and do not delimit the scope of the invention.

To facilitate the understanding of this invention, a number of terms are defined below. Terms defined herein have meanings as commonly understood by a person of ordinary skill in the areas relevant to the present invention. Terms such as “a”, “an” and “the” are not intended to refer to only a singular entity, but include the general class of which a specific example may be used for illustration. The terminology herein is used to describe specific embodiments of the invention, but their usage does not delimit the invention, except as outlined in the claims.

Detecting the structural impairments of physical structures is important to ensure their continued functionality and prevent losses due to structural failures. Traditional methods for detecting such impairments include: (i) visual inspection by experienced engineers, or (ii) measurements from the structure using fixed sensors such as strain gauges or accelerometers. Permanent monitoring systems can be expensive and difficult to install and maintain.

The present invention includes a novel community-driven data acquisition technique for detecting structural impairments in the absence of permanent sensor systems. The method relies on establishing the structural responses of infrastructure systems (e.g., accelerations, displacements, fatigue environment) through collection and filtering of indirect responses of user responses (e.g., a crowd-sourced smart phone acceleration data). The data gathering networks leverage the sensors (e.g., acceleration time histories, GPS data) on smart phones of individuals who have installed a smart phone application and opted-in to provide user anonymous data collection.

The method of the present invention includes one or more of the following novel contributions: (1) collection of spatio-temporal user device responses (i.e. acceleration, GPS data) that contain response information (i.e. frequency, acceleration amplitude) about the individual user vehicle and the infrastructure on which the vehicle is operating (e.g. roadway, bridge); and/or (2) separation and isolation of infrastructure response from individual user responses of the user device/vehicle.

The present invention involves the following major steps:

Obtaining time-varying sensor information on the smartphone including 3D accelerometer, gyroscope and GPS information is collected from smart phone devices and stored for further analysis and also uploaded to our server (without any user specific identification).

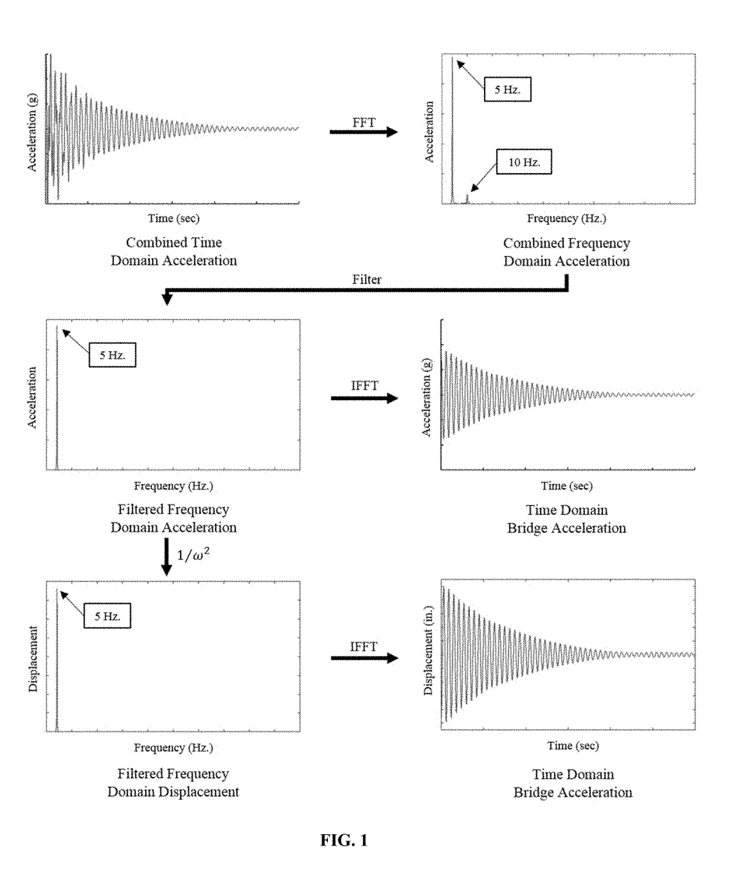

Providing User device responses (e.g. vehicle frequencies) are filtered to distinguish vibration response (e.g. frequencies, acceleration time histories) of supporting structural infrastructure (See FIG. 1).

Estimating structural responses are compared to analytical models and existing data streams for the same structure from different user devices to determine if there has been any significant change with time. Significant changes will trigger additional action to closely inspect the structure for potential impairments.

FIG. 1 is a flow diagram for separating user device and infrastructure responses 10. In step 12, the combined time domain acceleration is obtained. After Fast Fourier Transfer (FFT), the data is displayed in step 14, which includes the combined frequency domain acceleration. Next, in step 16, the data from step 14 is filtered and the filtered frequency domain acceleration is shown. The data from this step is filtered in two ways, as an inverse discrete Fourier transform (IFFT), that yields the results in step 18, which are the time domain bridge acceleration. Alternatively, the data is processed as the 1/ω² and then displayed in step 20 as the filtered frequency domain displacement. This data is then processed via IFFT to, in step 22, provide the final time domain bridge displacement.

The method taught herein allows engineers and stakeholders multiple methods of assessing structural behavior: (1) acceleration data can be used to estimate the stress ranges and stress cycles experienced by the structure (i.e. fatigue assessment, a major concern for structural infrastructure), (2) dynamic response content can be compared to analytical models of specific bridges, and (3) patterns of response of the same structure can be collected and compared against previously collected data.

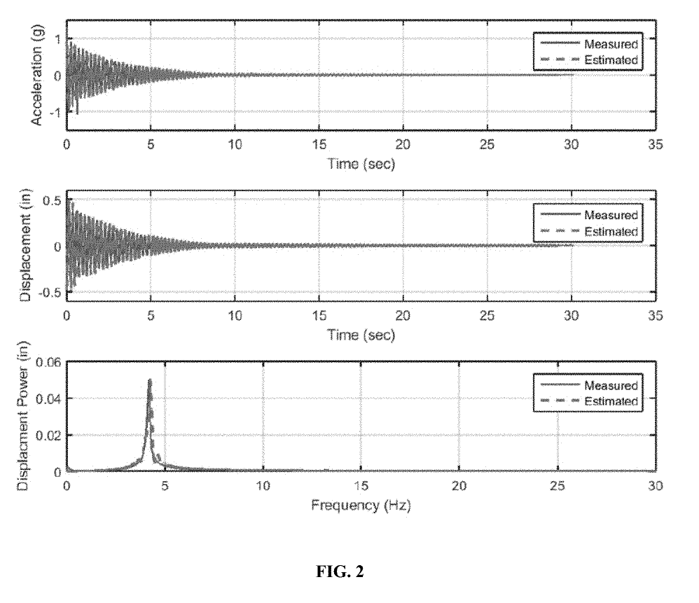

Modeling, laboratory, and field studies were performed to indirectly assess the behavior of a base structure from a smart phone on a vehicle. The laboratory study comprised a base structure and a secondary structure with separate natural frequencies attached in a static manner. The system was excited, and measurements of acceleration were taken from the smart phone attached to the secondary structure. Additionally, accelerations and strains of the frame were measured to estimate the frame acceleration and displacements. The response of the base structure was estimated from the smart phone on the secondary structure and compared to the known responses. Study results are presented in Table 1. An analytical estimate, using the finite element analysis software OPENSEES, was performed to model the test; the calculated natural frequency was 4.2 Hz. Direct measurements and Structural Response Estimation (SRE) estimates of the test are shown in FIG. 2. All analytical and study results show excellent agreement between SRE indirect measurements and direct measurements.

TABLE 1
Frame SRE Lab Summary

| | Frame | | Estimated | | Percent Difference | |
|---|---|---|---|---|---|---|
| | Frequency | Power | Frequency | Power | (%) | |
| Test | (Hz) | (in) | (Hz) | (in) | Frequency | Power |
| 1 | 4.30 | 0.08 | 4.36 | 0.07 | −1.56 | 17.77 |
| 2 | 4.30 | 0.06 | 4.39 | 0.05 | −2.06 | 11.36 |
| 3 | 4.20 | 0.07 | 4.26 | 0.05 | −1.32 | 16.31 |
| 4 | 4.30 | 0.08 | 4.39 | 0.09 | −2.20 | −15.19 |
| 5 | 4.30 | 0.05 | 4.34 | 0.04 | −1.00 | 9.69 |
| 6 | 4.20 | 0.10 | 4.23 | 0.09 | −0.73 | 8.30 |
| 7 | 4.20 | 0.10 | 4.23 | 0.09 | −0.73 | 11.00 |
| 11 | 4.20 | 0.05 | 4.25 | 0.05 | −1.14 | −2.00 |

TABLE 2
Pedestrian Bridge SRE Summary

| | | | | Mon- | Percentage | |
|---|---|---|---|---|---|---|
| | Bridge | Bridge | Monitored | itored | Difference | |
| | Frequency | Power | Frequency | Power | Frequency | Power |
| Test | (Hz) | (g) | (Hz) | (g) | (%) | (%) |
| Static01 | 3.207 | 0.081 | 3.237 | 0.084 | −0.92 | −3.56 |
| Static02 | 3.197 | 0.070 | 3.226 | 0.072 | −0.91 | −3.63 |
| Walk01 | 3.216 | 0.142 | 3.227 | 0.105 | −0.34 | 26.10 |

FIG. 2 shows three graphs for the Frame SRE Lab Summary. The first graph shows acceleration (g) as a function of time. The second graph shows displacement in inches over time. The third graph shows the displacement power in inches as a function of frequency in hertz (Hz).

A second series of studies were performed on a pedestrian bridge in the field. The smart phone vehicle was a bicycle, which was used as an indirect monitoring vehicle; the acceleration of the bridge and bike were recorded separately. The acceleration from the smart phone on the bicycle was used to estimate the bridge response under two conditions: a stationary bike and a bike being walked across the bridge. Table 2 presents all experimental results and indicates that the SRE estimation of the bridge frequency is within 1% difference of the measured bridge frequency.

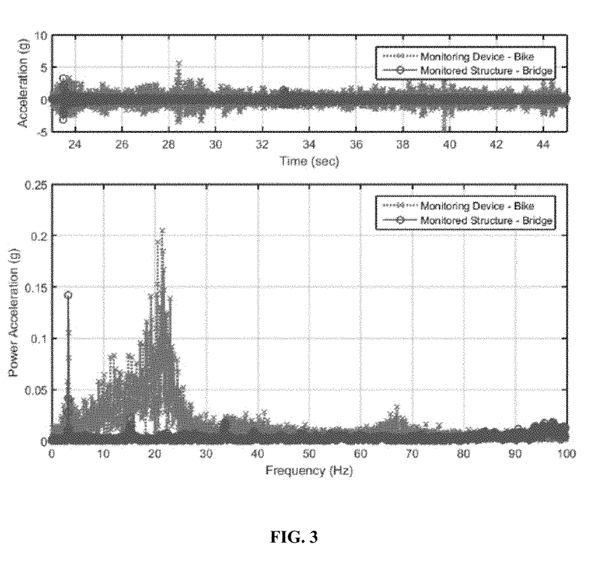

FIG. 3 shows the SRE frequency estimation for the stationary test; this most closely mimics the laboratory setting in which the user device system is stationary. The results are for a Bike Walk Test: Bridge vs. Cell Phone response (raw).

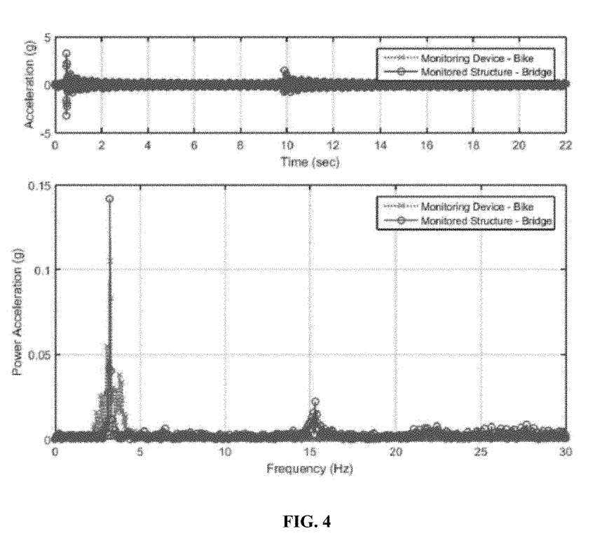

FIG. 4 shows the unfiltered frequency response of the walking test (Bike Walk Test: Bridge vs. Cell Phone response (after SRE)). The bridge frequency (3.2 Hz) can be seen, but there are many additional higher frequencies in the system. After the SRE procedure, these higher frequencies (from the walking bike system) are filtered and FIG. 4 shows the clear presence of the 3.2 Hz bridge frequency.

In one version of the method, infrastructure accelerations established from the proposed method can be converted directly into displacements, strains, and stresses to determine the response of the structure and characterize the fatigue environment. Such an assessment is critical in detecting structures that are experiencing high cycle fatigue at elevated stress ranges. Highway bridges, traffic signal structures, and other infrastructure components are susceptible to this high cycle fatigue.

Other potential applications include the corroboration and monitoring of changes in expected behavior of specific bridge types and even specific bridges. Behavior profiles from analytical models for typical structures are available for comparison to crowd sourced structural behavior profiles. This technique requires a priori knowledge of the nominal structural behavior.

Another extension might be the combination of data streams for individual structures from multiple smart phones and monitor the patterns for any changes. Data streams can be evaluated using any number of Structural Health Monitoring or Structural Impairment Detection algorithms found in the literature (e.g. Story and Fry 2013, Story and Fry 2014). The results of each instance and analysis comprise a health history of the individual structure.

It is contemplated that any embodiment discussed in this specification can be implemented with respect to any method, kit, reagent, or composition of the invention, and vice versa. Furthermore, compositions of the invention can be used to achieve methods of the invention.

It will be understood that particular embodiments described herein are shown by way of illustration and not as limitations of the invention. The principal features of this invention can be employed in various embodiments without departing from the scope of the invention. Those skilled in the art will recognize, or be able to ascertain using no more than routine experimentation, numerous equivalents to the specific procedures described herein. Such equivalents are considered to be within the scope of this invention and are covered by the claims.

All publications and patent applications mentioned in the specification are indicative of the level of skill of those skilled in the art to which this invention pertains. All publications and patent applications are herein incorporated by reference to the same extent as if each individual publication or patent application was specifically and individually indicated to be incorporated by reference.

The use of the word “a” or “an” when used in conjunction with the term “comprising” in the claims and/or the specification may mean “one,” but it is also consistent with the meaning of “one or more,” “at least one,” and “one or more than one.” The use of the term “or” in the claims is used to mean “and/or” unless explicitly indicated to refer to alternatives only or the alternatives are mutually exclusive, although the disclosure supports a definition that refers to only alternatives and “and/or.” Throughout this application, the term “about” is used to indicate that a value includes the inherent variation of error for the device, the method being employed to determine the value, or the variation that exists among the study subjects.

As used in this specification and claim(s), the words “comprising” (and any form of comprising, such as “comprise” and “comprises”), “having” (and any form of having, such as “have” and “has”), “including” (and any form of including, such as “includes” and “include”) or “containing” (and any form of containing, such as “contains” and “contain”) are inclusive or open-ended and do not exclude additional, unrecited elements or method steps. In embodiments of any of the compositions and methods provided herein, “comprising” may be replaced with “consisting essentially of” or “consisting of”. As used herein, the phrase “consisting essentially of” requires the specified integer(s) or steps as well as those that do not materially affect the character or function of the claimed invention. As used herein, the term “consisting” is used to indicate the presence of the recited integer (e.g., a feature, an element, a characteristic, a property, a method/process step or a limitation) or group of integers (e.g., feature(s), element(s), characteristic(s), propertie(s), method/process steps or limitation(s)) only.

The term “or combinations thereof” as used herein refers to all permutations and combinations of the listed items preceding the term. For example, “A, B, C, or combinations thereof” is intended to include at least one of: A, B, C, AB, AC, BC, or ABC, and if order is important in a particular context, also BA, CA, CB, CBA, BCA, ACB, BAC, or CAB. Continuing with this example, expressly included are combinations that contain repeats of one or more item or term, such as BB, AAA, AB, BBC, AAABCCCC, CBBAAA, CABABB, and so forth. The skilled artisan will understand that typically there is no limit on the number of items or terms in any combination, unless otherwise apparent from the context.

As used herein, words of approximation such as, without limitation, “about”, “substantial” or “substantially” refers to a condition that when so modified is understood to not necessarily be absolute or perfect but would be considered close enough to those of ordinary skill in the art to warrant designating the condition as being present. The extent to which the description may vary will depend on how great a change can be instituted and still have one of ordinary skilled in the art recognize the modified feature as still having the required characteristics and capabilities of the unmodified feature. In general, but subject to the preceding discussion, a numerical value herein that is modified by a word of approximation such as “about” may vary from the stated value by at least ±1, 2, 3, 4, 5, 6, 7, 10, 12 or 15%.

All of the compositions and/or methods disclosed and claimed herein can be made and executed without undue experimentation in light of the present disclosure. While the compositions and methods of this invention have been described in terms of preferred embodiments, it will be apparent to those of skill in the art that variations may be applied to the compositions and/or methods and in the steps or in the sequence of steps of the method described herein without departing from the concept, spirit and scope of the invention. All such similar substitutes and modifications apparent to those skilled in the art are deemed to be within the spirit, scope and concept of the invention as defined by the appended claims.

### REFERENCES

Costa Antunes, P., Miguel Dias, J., Varum, H., and Andre, P. (2014). “Dynamic structural health monitoring of a civil engineering structure with a POF accelerometer”. Sensor Review, 34(1), 36-41.
Brownjohn, J. (2007). “Structural health monitoring of civil infrastructure”. Philosophical Transactions of the Royal Society A: Mathematical, Physical and Engineering Sciences, 365(1851), 589-622.
Farrar, C., Doebling, S., and Nix, D. (2001). “Vibration-based structural damage identification”. Philosophical Transactions of the Royal Society A: Mathematical, Physical and Engineering Sciences, 359(1778), 131-149.
Feng, M., Fukuda, Y., Mizuta, M., and Ozer, E. (2015). “Citizen Sensors for SHM: Use of Accelerometer Data from Smartphones”. Sensors, 15(2), 2980-2998.
Ha, D., Park, H., Choi, S., and Kim, Y. (2013). “A Wireless MEMS-Based Inclinometer Sensor Node for Structural Health Monitoring”. Sensors, 13(12), 16090-16104.
Ozer, E., Feng, M., and Feng, D. (2015). “Citizen Sensors for SHM: Towards a Crowdsourcing Platform”. Sensors, 15(6), 14591-14614.
Park, K., Kim, S., Park, H., and Lee, K. (2005). “The determination of bridge displacement using measured acceleration”. Engineering Structures, 27(3), 371-378.
Story, B. A., and Fry, G. T. (2013). Methodology for Designing Diagnostic Data Streams for Use in a Structural Impairment Detection System,” Journal of Bridge Engineering, 10.1061/(ASCE)BE.1943-5592.0000556, 04013020.
Story, B. A., and Fry, G. T. (2014). “A Structural Impairment Detection System Using Competitive Arrays of Artificial Neural Networks,” Computer-Aided Civil and Infrastructure Engineering, 29: 180-190.

What is claimed is:

1. A method for detecting impairments of a structure in the absence of permanent sensor systems comprising:
obtaining time-varying sensor data on a user device;
filtering the time-varying sensor data obtained by the user device to determine a vibration response from structural infrastructure; and
estimating structural responses of the structure by comparing at least one of: dynamic (short-term) sensor data to an analytical model of the structure; or dynamic sensor data from different user devices at different points in time (long-term), to determine if there has been any significant change in the structure with time.

2. The method of claim 1, wherein the time-varying sensor information on the smartphone is selected from 3D accelerometer, gyroscope and GPS information.

3. The method of claim 1, wherein the time-varying sensor information is obtained without user-specific identification.

4. The method of claim 1, wherein the time-varying sensor information is uploaded to a server and stored for subsequent analysis.

5. The method of claim 1, wherein the time-varying sensor data is filtered by vehicle frequencies.

6. The method of claim 1, wherein to distinguish vibration response of supporting structural infrastructure is selected from frequencies and/or acceleration time histories.

7. The method of claim 1, wherein the finding of significant changes triggers additional action to closely inspect the structure for potential impairments.

8. The method of claim 1, wherein the user device comprise an application that requires user opt-in to gather the time-varying sensor data.

9. The method of claim 1, further comprising the step of converting the time-varying sensor data directly into at least one of: displacements, strains, or stresses to determine the response of the structure and characterize the fatigue environment.

10. The method of claim 1, further comprising the step of calculating a structural behavior profile from analytical models for a typical structure and comparing the structural behavior profile to the time-varying sensor data obtained from the user devices to the calculated structural behavior profile.

11. The method of claim 1, wherein the steps of obtaining time-varying sensor data; filtering the time-varying sensor data; and estimating structural responses is conducted via a code segment in non-transitory memory.

12. A method for detecting impairments of a structure in the absence of permanent sensor systems comprising:
obtaining time-varying sensor data on a smartphone with an application that requires user opt-in to gather the time-varying sensor data;
filtering the time-varying sensor data obtained by the user device to distinguish vibration response of the structure that includes at least one of: 3D accelerometer, gyroscope and GPS information; and
estimating structural responses of the structure to an analytical model and an existing data set for the same structure from the time-varying sensor data obtained from different smartphones to determine if there has been any significant change in the structure with time.

13. The method of claim 12, wherein the time-varying sensor information is obtained without user-specific identification.

14. The method of claim 12, wherein the time-varying sensor information is uploaded to a server and stored for subsequent analysis.

15. The method of claim 12, wherein the time-varying sensor data is filtered by vehicle frequencies.

16. The method of claim 12, wherein to distinguish vibration response of supporting structural infrastructure is selected from frequencies and/or acceleration time histories.

17. The method of claim 12, wherein the finding of significant changes triggers additional action to closely inspect the structure for potential impairments.

18. The method of claim 12, wherein the smartphones comprises an application that requires user opt-in to gather the time-varying sensor data.

19. The method of claim 12, further comprising the step of converting the time-varying sensor data directly into at least one of: displacements, strains, or stresses to determine the response of the structure and characterize the fatigue environment.

20. The method of claim 12, further comprising the step of calculating a structural behavior profile from analytical models for a typical structure and comparing the structural behavior profile to the time-varying sensor data obtained from the smartphone to the calculated structural behavior profile.

21. A non-transitory computer readable medium for detecting impairments of a structure in the absence of permanent sensor systems via crowdsourcing, comprising instructions stored thereon, that when executed by a computer having a communications interface, one or more databases and one or more processors communicably coupled to the interface and one or more databases, perform the steps comprising:
obtaining time-varying sensor data on a user device;
filtering the time-varying sensor data obtained by the user device to distinguish vibration response of the structure that includes at least one of: 3D accelerometer, gyroscope and GPS information;
estimating structural responses of the structure to an analytical model and an existing data set for the same structure from the time-varying sensor data obtained from different user devices to determine if there has been any significant change in the structure with time; and
at least one of storing or displaying the results obtained thereby.

22. A computerized method for detecting impairments of a structure in the absence of permanent sensor systems via crowdsourcing, comprising:
obtaining time-varying sensor data on a user device;
filtering the time-varying sensor data obtained by the user device to distinguish vibration response of the structure that includes at least one of: 3D accelerometer, gyroscope and GPS information;
estimating structural responses of the structure to an analytical model and an existing data set for the same structure from the time-varying sensor data obtained from different user devices to determine if there has been any significant change in the structure with time; and
at least one of storing or displaying the results obtained thereby.
